(19) United States
(12) Patent Application Publication
(10) Pub. No.: US 2014/0187303 A1
(43) Pub. Date: Jul. 3, 2014

(54) Methods for Enhancing Payouts and Play in Games of Chance

(71) Applicant: Scientific Games International, Inc., Newark, DE (US)

(72) Inventor: Kenneth Earl Irwin, JR., Dawsonville, GA (US)

(73) Assignee: Scientific Games International, Inc., Newark, DE (US)

(21) Appl. No.: 14/109,042

(22) Filed: Dec. 17, 2013

Related U.S. Application Data
(60) Provisional application No. 61/746,671, filed on Dec. 28, 2012.

(51) Int. Cl. G07F 17/32

(52) U.S. Cl. CPC G07F 17/3244
USPC 463/16

(57) ABSTRACT

A computer-implemented method establishes a payout schedule for a game of chance having an enhanced upper tier or a method of conducting a real time drawing for multiple jurisdictions. Arrangement is made with an insurer to provide insurance payment to the game provider in the event of payout of the enhanced upper tier amount, wherein the insurer receives a premium payment that is less than the upper tier payout amount. A computer system uses an algorithm known to the insurer and the game provider to randomly determine whether the upper tier payout will be awarded in the game of chance. One or more seeds are input into the computer system for use by the algorithm for random determination of whether the upper tier payout will be awarded, with each party contributing to generation of the seeds.

### PRIORITY CLAIM

The present invention claims priority to U.S. Provisional Application No. 61/746,671, filed Dec. 28, 2012.

### FIELD OF THE INVENTION

The present subject matter relates generally to control methods for payouts in a gaming environment, such as a lottery or multijurisdictional game (e.g., poker, Bingo, etc.) More particularly, the invention relates to control mechanisms for prize fund accelerators wherein contracts can pay additional (i.e., higher) payouts in excess of a budgeted prize fund or enable multiple gaming jurisdictions to securely pool players and associated funds in a common game wherein the drawing is secured by participating entities.

### BACKGROUND

Lottery games have become a time honored method of raising revenue for state and federal governments the world over. Traditional scratch-off and on-line games have evolved over decades, supplying increasing revenue year after year. However, after decades of growth, the sales curves associated with traditional games seem to be flattening out. Consequently, both lotteries and their service providers are presently searching for new forms of gaming to enhance player interest and participation, as well as to generate revenue for the government and other entities that benefit from the lottery proceeds.

Over the years, United States lotteries have come to appreciate the virtues of producing games with more entertainment value of higher prizes that can be sold at a premium price—e.g., extended play instant games, $2 Powerball, etc. However, these premium games are still limited to payout percentages established by law that are typically 50% for draw games (e.g., Pick 3, Pick 4, Powerball, etc.) and 65% for instant games. Thus, while higher prices can support higher prizes, the overall payout percentage remains the same, which can limit a game's appeal to a broader audience.

For example, it is widely known that Nevada law mandates that the minimum average payout or prize fund for a casino slot machine can be no less than 75%, yet most Las Vegas casinos have their slot machines set for average payouts between 90% to 95%. The reason for the 15% to 20% higher payout than required by law is due to the fact that casinos realize higher revenue from the higher payout because of massive increases in play volume. Thus, higher profits are realized for the casino with higher payouts, with the apparent optimum payout point for casino revenue ranging between 90% and 95%.

However, some state laws or lottery charters dictate that the payout or prize fund for a lottery must be set to around 65% for instant tickets and around 50% for draw games, and such games cannot realize the benefits of increased payouts. Hence, there is a need to provide enhanced payouts associated with traditional lottery games via legal methods for expanding the perceived prize fund. Ideally, these methods for expanding prize funds would also be applicable to all forms of gaming such as contests, slot machines, etc.

Additionally, new forms of gaming enabled by the Internet (e.g., Internet poker sites) require a quorum of players to wager real time on a common drawing. However, a real time quorum of players required before a real time drawing can be conducted creates problems for smaller gaming jurisdictions with impatient players exiting before a quorum can be achieved. Thus, it is desirable for various gaming jurisdictions to pool their players and resources with other jurisdictions to greatly reduce the time required to form a player quorum. However, the pooling of players and resources across multiple jurisdictions creates various security concerns that the overall play is fair and just. In quorum games with real time drawings like poker, this problem is particularly vexing since the players make bet decisions after real time drawings are conducted with the winner (and the winner's jurisdiction) receiving all the revenue from the play. Therefore, there is also a need to enable secure/fair play of real time draw games across multiple jurisdictions.

### SUMMARY

Objects and advantages of the invention will be set forth in part in the following description, or may obvious from the description, or may be learned through practice of the invention.

The present invention provides control mechanisms, systems, and methodologies related to prize fund enhancements that enable expanding the consumer perceived prize fund in games that do not necessitate increasing the basic prize fund beyond its legal maximum—e.g., 65% of the retail price. Additionally, these same methods can be also employed to expand the perceived prize funds other forms of gaming—e.g., casino slot machines, table games, etc.

In accordance with aspects of the invention, a computer-implemented method is presented for a game provider to provide an enhanced payout in a game of chance. The invention is not limited to a particular type of game, and has applicability for prize structures in a draw-type lottery game or a ticket-based lottery game (e.g., an instant ticket game). For example, the enhanced payout method may be applied to individual plays of the game of chance for particular players, wherein the randomized enhanced payout method determines whether the player is entitled to the enhanced payout value for a top prize in the game, or to a default payout value (non-enhanced top prize amount), in the event of a winning play of the game of chance.

The game provider may be, for example, a lottery game provider and the game of chance maybe a draw game having a tiered prized structure, or an instant ticket lottery game having a tiered prize structure. The method includes establishing a payout schedule for the game of chance with an enhanced upper tier value and a default lower tier value for the top prize in the game. Arrangements are made with an insurer to provide insurance payment to the game provider in the event of payout by the game provider of the enhanced upper tier of the payout schedule. The insurer receives a premium payment for the insurance that is less than the amount of the enhanced upper tier payout. An algorithm that is known to the insurer and the game provider is stored in a computer system and is used to randomly determine whether the enhanced upper tier value will be applied to a winning play in the game of chance. This determination may be made at the time a player purchases the lottery ticket (and made known to the player or indicated on the ticket at that time), or at a subsequent time, for example after the player is determined to be a winner of the top prize in the underlying game and before the final prize is determined via the algorithm.

At least one seed is input into the computer system as an input variable for the algorithm, wherein the algorithm uses the seed to randomly determine whether the enhanced upper tier value will be awarded. The process for selection of the seed is agreed to by the insurer and the game provider, with the actual value of the seed being unknown to the insurer and game provider until either the algorithm has determined (e.g., computed) the outcome, or until neither party can influence the algorithm outcome by manipulation of the seed. Each of the game provider and insurer contribute data or information for generation of the seeds that is maintained secret from the other respective party. At a time when neither of the game provider or the insurer can change their respective seed data or information, the one or more seeds are made known to the game provider and insurer for independent verification of the algorithm outcome by the game provider and insurer. The outcome of the algorithm is applied for payout in the game of chance in accordance with the outcome of the algorithm.

In a particular embodiment, the game of chance is a draw event, such as a lottery drawing, and the insurer receives the premium payment per draw event.

In a unique embodiment, each of the game provider and the insurer input a respective seed into the computer system for use by the algorithm, with the respective seeds being unknown to the other party. The seeds may be generated, for example, via a cryptographic protocol.

The parties may exchange seeds either before or after the outcome determination is made by the algorithm. For example, the seeds may be exchanged after the algorithm determination is made known to the parties so that the respective parties (having knowledge of the actual algorithm) can independently verify the algorithm results.

In still a further embodiment, the seeds may be exchanged by the parties in encrypted form such that neither party knows the other's seed until the parties subsequently exchange encryption keys to decode the encrypted seeds. With this embodiment, the parties may exchange their respective seeds in encrypted form before an outcome determination is made by the algorithm. With the decrypted seeds, either party may independently run the algorithm to verify the results.

In yet another embodiment, each of the game provider and the insurer provide a seed input to a separate event for determining a single combined seed that is input into the computer system for use by the algorithm, with the event for determining the combined seed being agreed to by the game provider and the insurer. This embodiment may be desired in that each of the game provider and the insurer can verify that their respective seed input was used to determine the combined seed without knowing the other party's seed input.

In still another embodiment, multiple game providers from various jurisdictions, and optionally the players themselves, may contribute a multiplicity of seeds to the know algorithm thereby ensuring that the outcome of a real time drawing is beyond the control of the game provider conducting the actual real time drawing and any one jurisdiction.

It should be appreciated that the known algorithm may be any one or combination of a randomized encryption function algorithm, such as a one-time-pad encryption function algorithm. The algorithm may be based on a periodic function principle. In other embodiments, the seed(s) to the known algorithm may be derived from a public domain source that is beyond the control of either of the game provider or the insurer, or example a stock market index, or the result of a sporting event, the results of a publicly disclosed Keno drawing, and so forth. The algorithm may be a generally known hash function.

### BRIEF DESCRIPTION OF THE DRAWINGS

FIG. 1 is a first representative example of a standard zero sum prize structure for a typical instant lottery game;

FIG. 2 is a first representative example of an enhanced prize structure for a typical instant lottery game based on the same fundamentals as FIG. 1;

FIG. 3 is a breakdown of the four possible top prize sub-tier drawings of FIG. 2 highlighting each outcome's probability, Expected Value (EV), and cost;

FIG. 4 is a flowchart of a representative example of an enhanced drawing generator with an algorithm enabling sub-tier prize awards based on the enhanced payout of FIG. 3;

FIG. 5 is a front plan view of a representative example of a prize line with a discrete distribution from “0” thru “999” illustrating the ranges of the various sub-tiers of the enhanced payout of FIG. 3;

FIG. 6 is a flowchart of a second representative example of an enhanced drawing generator with an algorithm enabling sub-tier prize awards based on the enhanced payout of FIG. 3;

FIG. 7 is a flowchart of a third representative example of an enhanced drawing generator with an algorithm being a one-time-pad enabling sub-tier prize awards based on the enhanced payout of FIG. 3;

FIG. 8 is a flowchart of a first representative example of a key/seed exchange between three parties using the Diffie-Hellman exchange protocol enabling sub-tier prize awards based on the enhanced payout of FIG. 3; and,

FIG. 9 is a flowchart of a representative example of a key/seed exchange between multiple game providers from various jurisdictions to be applied to a common known algorithm providing a real time drawing.

### DETAILED DESCRIPTION

Reference will now be made to one or more embodiments of the system and methodology of the invention as illustrated in the figures. It should be appreciated that each embodiment is presented by way of explanation of aspects of the invention, and is not meant as a limitation of the invention. For example, features illustrated or described as part of one embodiment may be used with another embodiment to yield still a further embodiment. It is intended that the invention include these and other modifications that come within the scope and spirit of the invention.

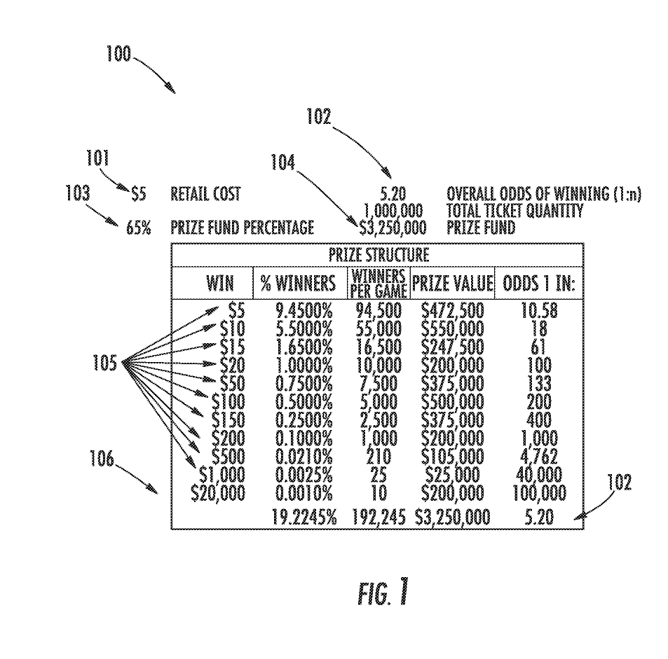

FIG. 1 depicts a typical prize structure 100 for an instant lottery game. As shown in FIG. 1, this typical example features instant tickets with a retail cost of $5 per individual ticket 101, with overall odds of winning of 1 in 5.2 (102), wherein 65% of the total retail sales 103 is devoted to the prize fund or $3,250,000 (104) for a million $5 tickets. This total prize fund 104 is then divided into ten different prize low- and mid-tier levels 105 ranging from $5 to a maximum of $1,000, with one final high-tier of ten prizes of $20,000 (106) each. Of course, FIG. 1 is only one of innumerable possibilities of traditional prize funds, with all traditional prize funds dividing the proceeds from the percentage of retail sales devoted to prizes (e.g., 65%—103 of FIG. 1) among a multiplicity of varying prize levels 105 and 106. In other words, all traditional prize funds simply allocate a portion of retail sales for prizes and divide that allocated amount into various prize tiers.

While this traditional method of funding prizes has resulted in sustained sales over the years with sophisticated refinements being made over how the prize fund is distributed over the various levels, the end product always remains a zero sum game, with lower or middle tiered prizes 105 being funded at the expense of high tier prizes 106. Thus, although it is readily known that large top prizes attract some players while other players favor more mid-tier prizes (the psychology being that these players have a realistic chance of winning mid-tier prizes), appealing to both sets of players in a zero sum prize allocation becomes at best a precarious balancing act, with the value of the top prize 106 often being reduced to fund more mid-tier prizes 105.

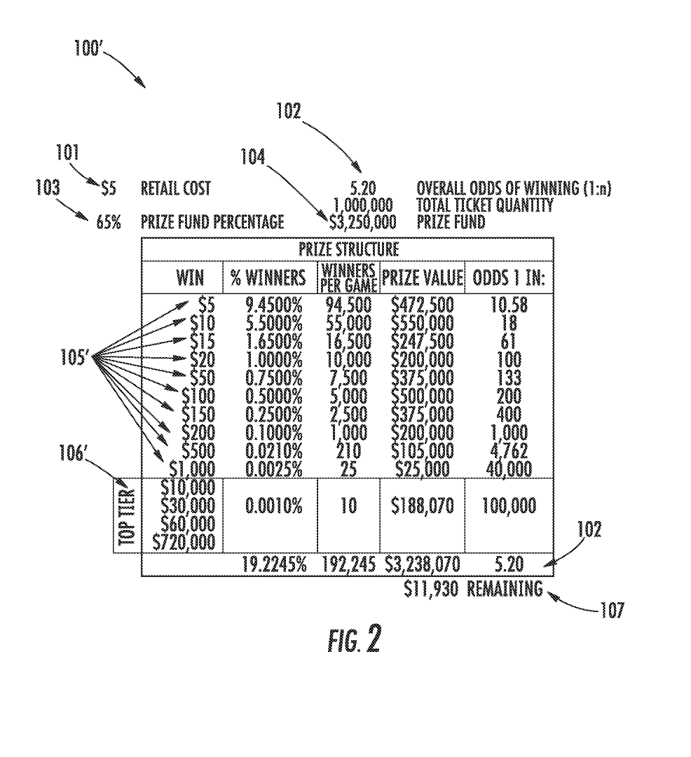

However, if a portion of a traditional zero sum prize fund is allocated to a separate insurance policy that pays out higher returns under certain predefined circumstances, the top prize to a particular game can be advertised to range from minimum to maximum values. This is especially true if the outcome of the predefined circumstance is unknown at the time of the sale of the ticket. For example, FIG. 2 illustrates an enhanced prize fund 100′ with the same basic parameters (i.e., $5 retail value per ticket 101, 5.20 overall odds of winning 102, 65% prize fund 103, resulting in $3,250,000 allocated for prizes 104) as FIG. 1, yet its top prize tier 106′ ranges from a low of $10,000 to a high of $720,000. Additionally, although the enhanced prize fund example of FIG. 2 has the added advantage of a potential significantly higher top prizes (i.e., $20,000 in the zero sum example of FIG. 1 versus $720,000 in the enhanced example of FIG. 2), it still maintains the identical lower tier prize structure 105′ while at the same time costing less—i.e., $11,930 remainder 107 from the allocated $3,250,000 prize fund 104.

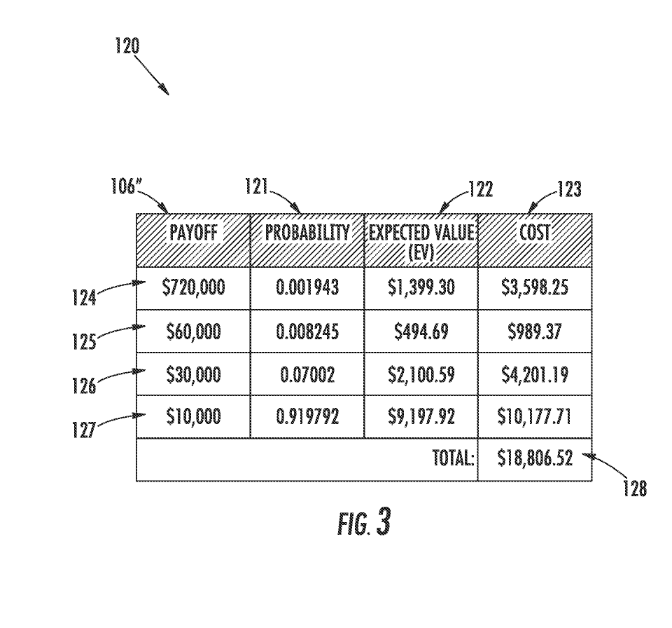

This reduction in overall costs while at the same time increasing the possible top prize in the example of FIG. 2 is made possible through the previously mentioned insurance policy enabling a range of top prize payouts from $10,000 to $720,000 (106′), effectively dividing the ten $20,000 top prizes 106 of the example of FIG. 1 into ten separate top prize drawings 106′ wherein the results can vary from $10,000 to $720,000 (FIG. 2). A further breakdown of the $10,000 to $720,000 top prize drawings 106′ is provided in FIG. 3. In FIG. 3, the four possible top prize drawing outcomes 106″ are listed in sequential rows 124 thru 127, with each prize outcome having its separate probability 121, Expected Value (EV) 122, and cost 123 listed in its respective row. For example, the highest possible payout $720,000 listed in row 124 has a probability of 1 in 0.001943 of paying out on any particular drawing, resulting in an EV of $1,399.30, with a cost to the prize fund 100′ (FIG. 2) of $3,598.25 per drawing (FIG. 3). Conversely, the lowest possible payout $10,000 listed in row 127, has a probability of 1 in 0.919792 of paying out on any particular drawing, resulting in an EV of $9,197.92, with a cost to the prize fund 100′ (FIG. 2) of $10,177.71 per drawing (FIG. 3). When all four top prize drawing outcomes in this example (i.e., $720,000—124, $60,000—125, $30,000—126, and $10,000—127) costs 123 are summed together, the $18,806.52 total 128 constitutes the cost of the insurance policy per top prize drawing. In other words, for an $18,806.52 cost 128 for each occurrence of a top tier prize (e.g., ten occurrences in FIG. 2) in a prize fund, a drawing can be conducted with outcomes varying from $10,000 to $720,000 in this example. Therefore, the reduction in cost with an increased top prize range is made possible by offering multiple sub-tiers for the top prize with associated probabilities that weigh heavier with the lowest sub-tier prize (e.g., around 92% for $10,000) than the higher sub-tiered prizes (e.g., around 7% for $30,000, around 0.8% for $60,000, and around 0.2% for $720,000). The underlining marketing assumption being that for consumers motivated by top prizes, there is very little difference between a guaranteed $20,000 top prize and a probable $10,000 top prize; however, the possibility of receiving potentially life-changing funds (e.g., $720,000) adds to the overall allure of the game in this example. Of course, it should be appreciated that numerous other enhanced prizes at different tiers are possible (e.g., mid-tier) within the scope and spirit of the invention.

Of course, the benefits of having an enhanced prize fund are only of academic interest without an insurance company willing to assume the risk of variable prize drawings. This lack of insurance problem is compounded if the variable prize drawings take place after the ticket is sold—i.e., approximately real-time when a variable prize winner attempts to determine which sub-tier his winnings qualify for. The primary problem being the lack of trust that would naturally exist between the insurance company and the lottery/contest-provider with the insurance provider not having confidence in the lottery/contest-provider's ability to conduct a secure and fair (i.e., unbiased) drawing and vice-versa. Indeed, the lack of ensuring a secure and fair drawing may be one of the chief factors that have limited lotteries to zero sum prize funds to date.

However, by either trading seed data between both parties (e.g., lottery/contest-provider and insurance company) and/or by using dynamic outside seed data (e.g., data randomly or pseudo-randomly generated by outside parties or forces) exchanged through cryptographic protocols, the vexing problem of ensuring a secure and fair enhanced prize drawing can be resolved. Furthermore, with the correct application of the aforementioned cryptographic protocols, secure and fair enhanced prize drawings can also be conducted after the sale of winning tickets.

Generally speaking, applying cryptographic protocols to ensure a secure and fair enhanced prize drawing involves agreeing on one or more numerical seeds that are applied to a known algorithm that has been previously agreed to by both sides of the drawing—e.g., the gaming service provider and insurance company. Putting aside the problem of mutually agreed to seed generation, applying (an) agreed to seed(s) to a (mutually agreed to) known algorithm that has been determined to be unbiased in its output no matter what the seed(s) input resolves the enhanced drawing problem, especially in the special circumstance of drawings that occur after the winning tickets are sold to the consumer. This is possible since both sides have knowledge of and (presumably) a copy of the algorithm itself, and it becomes a simple matter for both sides to apply the agreed to seed(s) to the known algorithm, with the resulting output immediately known to both sides. Thus, if the known algorithm's output indicates that the enhanced drawing did not win anything over the base prize, the base prize can be immediately awarded to the consumer without the need to consult the insurance company. Likewise, if the known algorithm's output indicates that a higher sub-prize tier has been won, the higher prize could still be immediately awarded with the insurance company reimbursing the gaming service provider for the higher payout.

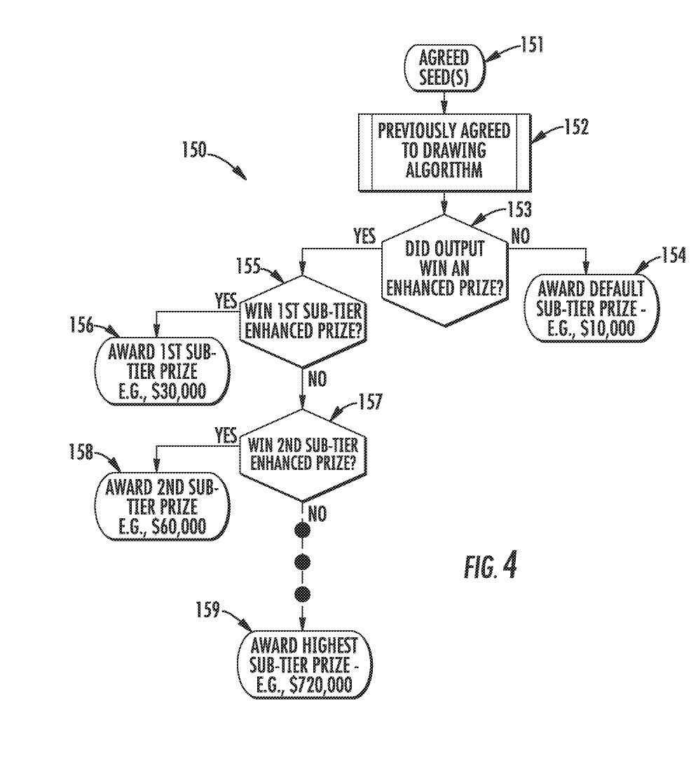

For example, FIG. 4 illustrates a flowchart 150 of applying agreed to seed(s) 151 to a mutually agreed to known algorithm 152. For illustrative purposes in this example, the disclosed process will select the four sub-tier prizes (i.e., 124 thru 127) from the enhanced prize drawing 120 of FIG. 3. The process of FIG. 4 may be implemented at various times, depending on the particular game scenario. For example, the process may be implemented after it has been determined that the player is a winner in the underlying base game. In other embodiments, the process may be implemented at the time the player purchases their ticket or other type of entry into the base game. The ticket or entry may then indicate whether or not the player is eligible for the enhanced payout (i.e., upper tier value) in the event of a win in the underlying game, or a particular sub-tier within the upper tier value.

Returning to the illustrative example of FIG. 4, once the agreed to seed(s) 151 are applied to the known algorithm 152, the algorithm's output determines what sub-prize tier will be awarded. The output of the known algorithm 152 can be ordinal numbers, pure binary, etc. the significant point being that the known algorithm's 152 output is deterministic from the input seed(s) with a discrete distribution (i.e., finite set) finally producing a pseudo-random (e.g., equal probability of any unit in its output occurring over the range of possible inputs, with entropy maintained over strings of outputs, etc.) Assuming the known algorithm 152 operates correctly, its output would be confirmed to determine which sub-tier prize would be awarded.

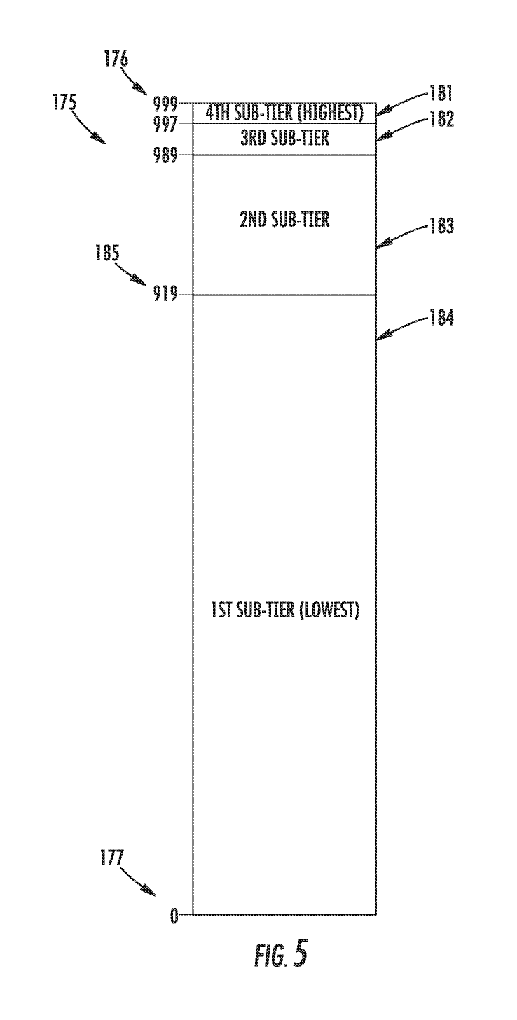

One possible way (of many) would be to test if the output falls within a series of ranges that cover the entire discrete distribution of the possible algorithm outputs. For example, FIG. 5 illustrates the discrete distribution output 175 of known algorithm 152 (FIG. 4) as one thousand ordinal numbers ranging from “0” (177—FIGS. 5) to “999” (176). Also illustrated in FIG. 5 are the four sub-tier enhanced prize levels (i.e., 124 thru 127 of FIG. 3) relegated to sub-ranges (i.e., 181 thru 184 as shown in FIG. 5) of known algorithm's 152 (FIG. 4) one thousand possible ordinal number outputs—i.e., FIG. 5: “0” (177) to “999” (176). Thus, FIG. 5 diagrammatically illustrates one method of how the output of known algorithm 152 (FIG. 4) could determine the enhanced prize awarded.

Returning to the flowchart of FIG. 4, the output of known algorithm 152 is then applied to a series of logic gates 153, 154, 155, and 157 to award the appropriate prize. The first logic gate 153 testing to determine if an enhanced prize is awarded—i.e., a prize that would trigger an insurance payment, or if the default lowest tier top prize applies. In the example of FIG. 4, which is modeled after the enhanced prize structure of FIG. 3, no enhanced prize award would mean the consumer actually the lowest (e.g., default) top prize of $10,000 (154—FIG. 4) with the insurance company still collecting a premium. However, in the event that the output of known algorithm 152 does produce an enhanced prize payout'e.g., an ordinal number ranging from “919” (185) thru “999” (176) as shown in the example of FIG. 5—the next logic gate 155 (FIG. 4) will be employed to determine if the enhanced prize is the next sub-tier level award—e.g., $30,000 (156)—or a higher prize. Finally, if a still higher prize is to be awarded, the third logic gate 157 would determine if the output from the known algorithm 152 would determine that the next 158 (e.g., $60,000) or the highest 159 (e.g., $720,000) tier is awarded. Again, since the determination of the enhanced prize is made by the known algorithm 152 based on mutually agreed to seed(s) 151, the enhanced prize(s) can be awarded instantly without the need to consult with the insurance company prior to awarding payment.

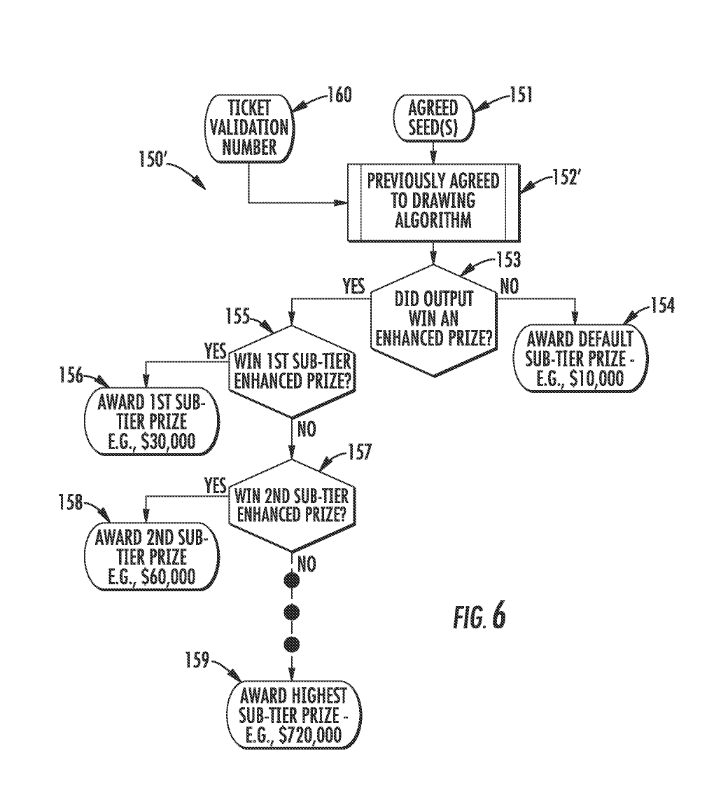

Of course, it should be appreciated that there are multiplicities of methods to determine the prize award(s) of the enhanced prize structure from the known algorithm 152 outputs, with the example of FIG. 5 merely serving as an instructive sample based on the enhanced prize structure of FIG. 3. Indeed, the known algorithm 152 (FIG. 4) could use the same process to also support no payout whatsoever under some circumstances, or more sub-level prizes can be introduced, etc. Also, data additional to the agreed to seed(s) can also be employed as part of the input to the known algorithm 152 to further randomize the output—e.g., adding the validation number 160 (FIG. 6) from the winning ticket as an additional input to known algorithm 152′ in a modified example 150′ of an enhanced drawing generator.

From the previous example it can be seen that the mutually agreed to known algorithm 152/152′ (FIGS. 4 and 6 respectively) is the mechanism that actually determines whether an enhanced prize will be awarded based on the seed(s) input. This is not to imply that the known algorithm 152/152′ need be complex; so long as the algorithm is deterministic from the input seed(s) with a discrete distribution producing a pseudo-random output, it is suitable for determining enhanced prize payouts. For example, a one-time-pad, a mathematically provable perfect cryptographic encryption scheme yet fundamentally simple algorithm can be employed as the known algorithm 152/152′. A one-time-pad is simply a plaintext sequence of data of some fixed length encrypted by a key that is a random sequence of data of the same length, wherein the encryption function is a modulo operation of the plaintext and key—e.g., encrypting English text would require a modulo 26 operation, encrypting decimal numbers would require a modulo 10 operation, etc. Assuming the encryption key is truly random and kept confidential, a one-time-pad system is perfectly secure, since every plaintext message is equally possible there is no way to determine which plaintext is the correct one even if all possible key combinations are attempted.

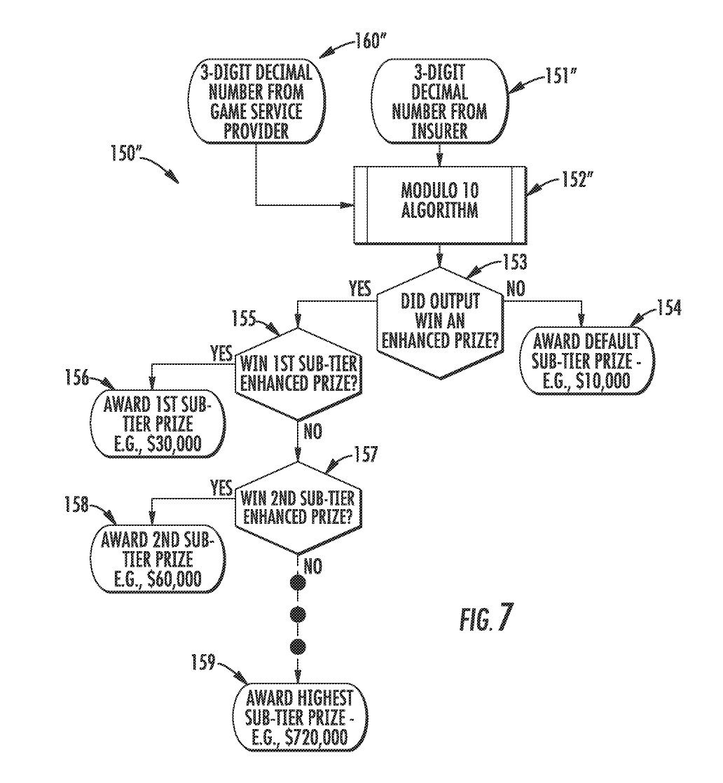

The general concept of one-time-pad encryption can be utilized as the known algorithm 152″ for the enhanced drawing generator 150″ of FIG. 7. In the embodiment illustrated in FIG. 7, the enhanced drawing generator 150″ effectively incorporates one-time-pad encryption as the known algorithm 152″. In the figure, the known algorithm is simply a modulo 10 process 152″ that accepts one seed as the plaintext (e.g., insurer 151″) to be encrypted with the other seed (e.g., game services provider 160″) functioning as the one-time-pad encryption key. Since each seed comes from a different source (i.e., one from the insurer 151″ and one from the game services provider 160″), so long as the seeds selected by each entity were random (or at the very least unpredictable by the other entity) and were not shared prior to being committed for an enhanced prize drawing, the system is perfectly secure against either entity knowingly influencing the outcome of the enhanced drawing. In other words, since neither the insurer nor the game services provider know what value will be picked by the other entity and each entity seed is applied to a modulo 10 operation 152″, the final output of the modulo 10 known algorithm can be any possible number within the discrete distribution of the seeds and the algorithm—e.g., one-thousand possible outcomes using three decimal digit seeds applied to a modulo 10 operation 152″. For example, assume the insurer seed 151″ is “123” and the game services provider seed 160″ is “111”, the output of the modulo 10 known algorithm 152″ would be “234”, however changing either seed would completely change known algorithm's 152″ output—e.g., if the game services provider seed 160″ is changed to “000” the output would be “123”.

In other embodiments, more complex algorithms can also be utilized as the know algorithm 152/152′ (FIGS. 4 and 6 respectively) so long as a deterministic, unbiased distribution of its output is maintained over a discrete distribution. For example, other encryption schemes such as the Advanced Encryption Standard (AES) could function as the known algorithm 152/152′ with the game services provider and insurer's seeds functioning as the plaintext and key (or vice versa). Another example would be utilizing cryptographic hash functions (e.g., Secure Hash Algorithm—SHA) as the known algorithm 152/152′. In this example, rather than one seed functioning as the plain text and the other as a cryptographic key, the two seeds would simply be concatenated together before being applied to the hash function, with the resulting hash constituting the output that determines if an enhanced prize is awarded or not.

The known algorithm enhanced drawing generator need not necessarily be limited to encryption or hash functions, in still another embodiment a Pseudo Random Number Generator (PRNG) such as a Linear Congruential Generator (LCG) or Mersenne twister can function as the known algorithm 152/152′. In these embodiments, one entity seed could function as the starting seed with the other controlling the number of iterations. Alternatively, the two entities seeds could be concatenated or hashed together to function as the start seed with a known number of iterations or another seed still controlling the number of iterations.

In yet another alternative embodiment, the known algorithm 152/152′ need not produce an output over a discrete distribution; rather the known algorithm 152/152′ could have a variable length output and still be of utility for enhanced prize determination. For example, the modulo 10 one-time-pad encryption known algorithm 152″ of the enhanced drawing generator 150″ of FIG. 7 could be modified to perform a modulo 26 function instead. In this embodiment, the known algorithm would be designed to accept English letters as the seeds with multiple letter or even phrases or sentences processed one at a time with the resulting cipher text output concatenated. Obviously, if the modulo 26 function is employed as the known algorithm 152/152′, the output string could be variable and therefore a single prize award system similar to the prize range assignments 175 line of FIG. 5 would pose logistical challenges. However, a variable or excessively large (e.g., 64-bit word AES encryption) output from known algorithm 152/152′ can nevertheless be accommodated with a multiplicity of different prize values by evaluating the output with a second periodic algorithm or hash function. In the embodiment of a periodic algorithm, various repetitive groupings could indicate varying prize values. For example, a numerical known algorithm 152/152′ with a theoretical infinite or very large output (e.g., a Mersenne twister with a very long period of 2¹⁹⁹³⁷) could have periodic prize groupings such as illustrated in FIG. 5 only repeated over every one thousand digits—e.g., 4^{th} Sub-Tier award 181 (FIG. 5) for output: “997” thru “999”, “1997” thru “1999”, “2997” thru “2999”, etc.

All of these embodiments can function as the known algorithm 152/152′ for the enhanced drawing generator, because the final output cannot be predicted unless all seeds are known a priori. Thus, because the system derives its security from the unknown nature of the each entity's seed (or an outside seed) to the other, or the seed selection process itself, the management and security of the seeds and the exchange process is critical to the integrity of the enhanced drawing generator.

In a preferred embodiment, the seeds can be simply derived from mutually agreed to published external sources beyond the control of either the insurer or the game services provider—e.g., Dow Jones Industrial Average, published periodic Keno draw numbers from a lottery unrelated to the advanced drawing, a cryptographic hash of the closing values of the NASDAQ stock exchange, etc. With this embodiment, the initial agreement between the insurer and the game services provider would include specified times and dates in the future where the seed data would be culled. Since, in this embodiment the seed data is controlled by means beyond each interested party (e.g., the insurer and the game services provider) and is widely published in the public domain, the drawing system can be assumed secure so long as the agreed to seed collection is sufficiently in the future. Of course, a multiplicity of seeds can be culled in this manner at periodic or variable times enabling variable drawing results depending on when the participant enters the drawing.

In addition to outside sources beyond the control of interested parties, as previously discussed with the example of one-time-pad encryption, seeds chosen by interested parties can be exchanged with the resulting output being a function of the two keys. However, since the security of the system relies on no party being able to guess the selected seed of the other, the seed exchange protocols between the parties is critical and must ensure that each party's seed is committed before the other parties seeds are known to them. One way to accomplish this exchange is by each party sending their selected seed to the other party as encrypted cipher text. Only when the cipher text seeds are received by all parties will the decryption keys be exchanged, thereby allowing all parties to observe the resultant clear text seeds and ultimately calculate the drawing outcome via known outcome algorithm 152/152′.

In another embodiment, existing well-known security protocols can be employed to affect seed exchanges. These well-known protocols have the advantage of being time tested and hardened with virtually any vulnerabilities being known and therefore addressable. For example, the Diffie-Hellman key exchange protocol is a well-known method of exchanging cryptographic keys that can be adapted to interested party seed exchanges and ultimately the determination of the seed(s) that are applied to known outcome algorithm 152/152′.

Specifically, the Diffie-Hellman key exchange method allows two parties that have no prior knowledge of each other to jointly establish a shared secret key (seed) over an insecure communications channel. Thus, Diffie-Hellman establishes a shared secret that can be used to share a common encryption key (i.e., ‘common secret’) or seed by exchanging data. Thus, the Diffie-Hellman method could be employed to generate the drawing seed applied to known outcome algorithm 152/152′ by simply using the resulting common secret as the draw seed. Since this resulting common secret seed is a function of two parties' secret seeds as well as a common starting point, both parties are free to select whatever secret seed they chose, which ultimately controls the final common secret seed (i.e., drawing seed). Or to put it another way, by using Diffie-Hellman as the exchange protocol, each party (e.g., the insurer and the game services provider) can know their secret key (seed) was used to produce a combined secret key (i.e., drawing seed) without having to reveal their own secret key to each other or to be able to control the final outcome drawing seed. Furthermore, variants of the Diffie-Hellman exchange protocol can be applied to allow additional parties to contribute to the final outcome of the draw seed.

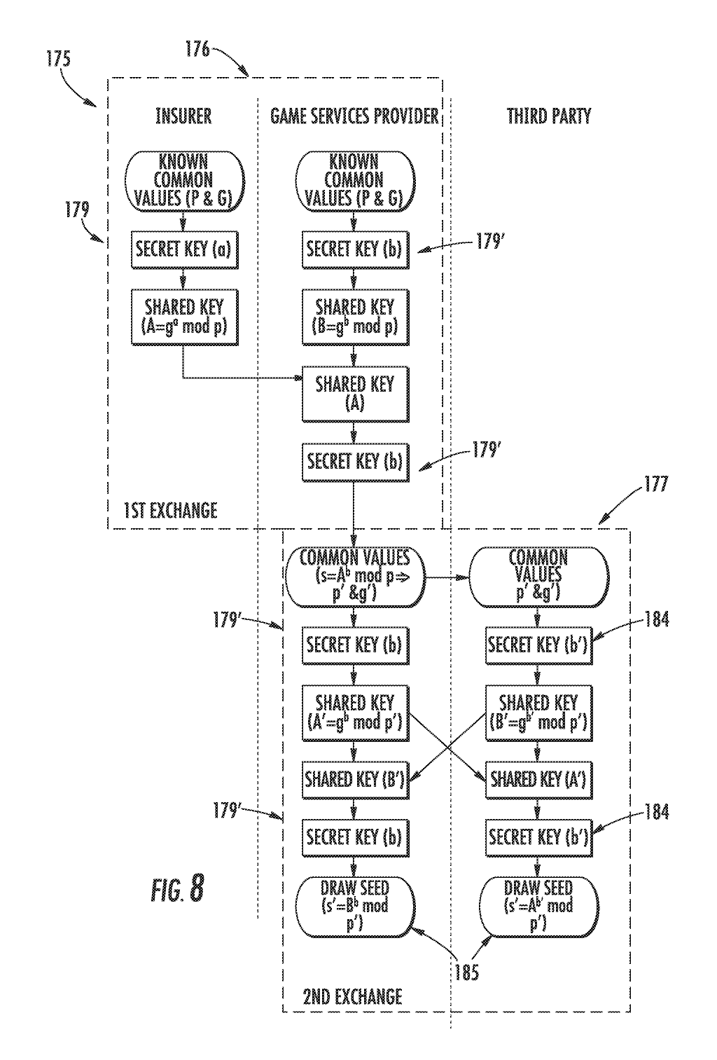

For example, FIG. 8 illustrates a modified Diffie-Hellman 175 one-way key/seed exchange that can be utilized in several iterations or exchanges, creating a custody chain where each interested party contributes to the final draw seed with no one party being able to force the outcome to a specific state. As illustrated in FIG. 8, in this one-way key exchange 175, the final value 181 from the first exchange pairing 176 is then split to produce the initial Known Common Values (i.e., p′ and g′) 183 and 183′ for the second Diffie-Hellman key exchange 177. Notice that with the second key exchange, there is no need for the intermediate party (e.g., lottery/contest provider) to change their key 179′ from the first exchange (i.e., b) 179′. Thus, the above Diffie-Hellman one-way key illustrates three different secret keys (i.e., a, b, & b′) 179, 179′, and 184 from three separate parties all contributing to a final draw seed 185 with no party gaining knowledge of any of the other parties' secret keys. Thus, since the three parties keys (i.e., a, b, & b′) 179, 179′, and 184 are kept secret from each other until the final draw seed 185 is determined, no one party can influence the final draw seed 185 outcome. After the final draw seed 185 is determined, the previously secret seeds 179, 179′, and 184 can be exchanged between the parties allowing everyone to authenticate the final draw seed 185. Of course, as is obvious to one skilled in the art, other protocols (e.g., Kerberos) can be employed between interested parties to ultimately determine the final drawing seed that is applied to known outcome algorithm 152/152′.

In one preferred method embodiment, the multiple parties (e.g., insurer, game provider, third party) access a portal, such as web portal or other comparable platform as known to those of skill in the art. The portal may be protected by a firewall to provide security for the web portal to prevent unauthorized access to system software or data. The web portal may be configured to create and encrypt seeds or seed components for each of the parties with access to web portal. These parties may supply information used to create the seeds as required by the seed generation process. For purposes of example only, the seeds may be established by the state of a computer system, such as the web portal, a cryptographically secure pseudorandom number generator, a hash algorithm, from a hardware random number generator, or via other means as known to those skilled in the art. In one embodiment, the seeds could be hashed with a public result over which neither party has any control, for instance, the listing of gold prices on a particular day or a result such as a PowerBall drawing. Indeed, the parties could further agree that the agreed to public result could be further manipulated by an algorithm before being used to create the game entries.

After the seeds are generated, they may be transferred to a location such as a secured server, or other suitable device as known to those of skill in the art. At the secure server, the seeds or seed components may be combined to form a final seed. The seeds or seed components may be combined via processes known to those of skill in the art such as by using algorithms. The algorithm used to combine the seeds may be a custom and proprietary algorithm developed specifically for the purpose of combining multiple seeds (or integers) into a single, final seed number. After the final seed has been generated, it is made available to a specialized seed server, or other suitable device as known to those of skill in the art, and stored therein. The final seed may reside either at the secure server or at a different server wherein the algorithm is run, depending on the desired security scenario.

It should be appreciated that the utility of an exchange of a multiplicity of seeds or one or more seeds derived from an outside source is not only limited to game and insurance providers. In yet another embodiment, a multiplicity of seeds can be provided from multiple game providers of different jurisdictions to a known algorithm controlling a common real time drawing(s). In this embodiment, the seed exchange(s) between the differing jurisdiction game service providers would enable rapid secure real time drawings for Internet based games (e.g., poker, pooled Bingo across multiple jurisdictions, pooled Keno, etc.) In other words, the combination of seeds from various jurisdictions or the use of outside seeds beyond any interested parties control would both reduce the waiting time to accumulate a sufficient number of players for a quorum as well as ensure that no one jurisdiction or entity was solely responsible for the security/integrity of the real time drawing(s).

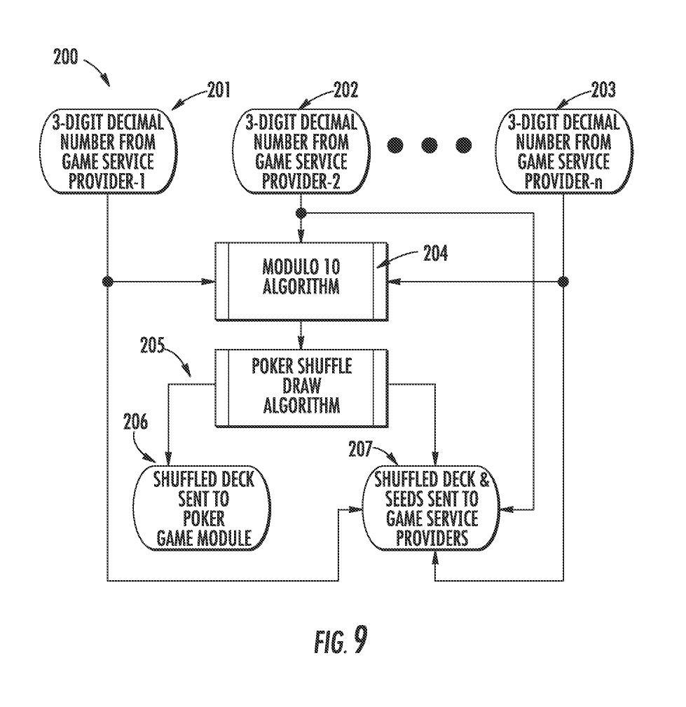

For example, FIG. 9 illustrates one possible embodiment of a system 200 enabling a common secure drawing for a poker game across multiple jurisdictions. As illustrated in FIG. 9, a multiplicity of game service providers 201, 202, and 203 each provide their own seeds to a common know algorithm 204. In addition, the seeds from each service provider are transmitted to the other participating service providers 207 after all service provider seeds have been received.

In this example, the common known algorithm 204 is a one-time pad for decimal numbers, however other algorithms may be employed (e.g., AES, hashes, Diffie-Hellman, etc.) to the same effect. Returning to system 200, the common known algorithm 204 accepts the multiplicity of seeds from the different game service providers 201, 202, and 203 from multiple jurisdictions producing an algorithmically linked common real time drawing output that is applied to shuffle draw algorithm 205. Shuffle draw algorithm 205 then utilizes the common real time drawing output of 204 to determine the shuffle of a virtual card deck. The resulting shuffle is then sent to a common game module 206 for dealing virtual cards to the players from a multiplicity of jurisdictions as well as to all game service providers participating in the multijurisdictional game 207. Thus, the shuffle of the multijurisdictional game virtual card deck is a function of the input of each game service provider 201, 202, and 203.

The various control functionalities of the present method embodiments are computer-implemented by any suitably configured computer server, system or network that interfaces with the game provider and insurer, and with any other party that may participate in the functionalities. For example, the game provider may utilize a central host computer system in the conduct of a lottery game in a given jurisdiction. This host computer system may also be in communication with a host system maintained by the insurer for exchange of data necessary to carry out the present control methods. In a particular embodiment, either of the game provider host computer or the insurer host computer may function as the computer system that stores the algorithm and receives the seed(s) or seed inputs from the respective parties, with the algorithm outcome being transmitted to the other party's computer system. In an alternate embodiment, a third party computer system (independent of the game provider and insurer) may be used to store the algorithm, receive the seed data from the game provider and insurer, and compute the algorithm outcome, which is then transmitted to the respective computer systems of the game provider and insurer. It should be readily appreciated that the computer-implemented functionalities may be widely configured within the scope and spirit of the invention, and that the invention is not limited to any particular hardware or software configuration.

What is claimed is:

1. A computer-implemented method for a game provider to provide an enhanced payout in a game of chance, comprising:
establishing a payout schedule for the game of chance, the payout schedule having an enhanced upper tier value and a default lower tier value for a top prize in the game of chance;
arranging with an insurer to provide insurance payment to the game provider in the event of payout by the game provider of the enhanced upper tier value, wherein the insurer receives a premium payment for the insurance that is less than the enhanced upper tier value;
storing an algorithm known to the insurer and the game provider in a computer system, the computer system using the algorithm to randomly determine whether the enhanced upper tier value will be awarded in the game of chance;
inputting one or more seeds into the computer system as a variable input for the algorithm, the algorithm using the seeds for determination of whether the enhanced upper tier value will be awarded;
wherein each of the game provider and insurer contribute data or information for generation of the seeds that is maintained secret from the other respective party;
at a time when neither of the game provider or the insurer can change their respective seed data or information, providing the one or more seeds to the game provider and insurer for independent verification of the algorithm outcome by the game provider and insurer; and
conducting payout in the game of chance in accordance with the outcome of the algorithm.

2. The method as in claim 1, wherein the default lower tier value is awarded in the game of chance in the event that the algorithm determines that the enhanced upper tier value will not be awarded in the game of chance.

3. The method as in claim 1, wherein the game of chance is a draw-type game, and the insurer receives the premium payment per draw event.

4. The method as in claim 1, wherein each of the game provider and the insurer input a respective seed into the computer system for use by the algorithm, the respective seeds being unknown to the other party prior to exchange of the seeds between the game provider and the insurer.

5. The method as in claim 4, wherein the seeds are exchanged in encrypted form between the game provider and the insurer, and the game provider and the insurer exchange encryption keys after the exchange of the encrypted seeds.

6. The method as in claim 5, wherein each of the game provider and insurer can independently verify the outcome of the algorithm with the other party's decrypted seed.

7. The method as in claim 1, wherein each of the game provider and the insurer provide a seed component to a separate event for determining a single combined seed that is input into the computer system for use by the algorithm, wherein the seed components are maintained secret from the other respective party.

8. The method as in claim 7, wherein each of the game provider and the insurer verify that their respective seed input was used to determine the combined seed without knowing the other party's seed input.

9. The method as in claim 1, wherein the known algorithm is a randomized encryption function algorithm.

10. The method of claim 9, wherein the known algorithm is a one-time-pad encryption function algorithm.

11. The method of claim 1, wherein the known algorithm is based on random determination of a periodic function.

12. The method of claim 1, wherein the seed for the known algorithm is derived from a public domain source that is beyond the control of either of the game provider or the insurer.

13. The method of claim 12, wherein the seed is a function of a publicly disclosed Keno drawing.

14. The method of claim 1, wherein the known algorithm is a generally known, hash function.

15. The method of claim 1, wherein the known algorithm is any one of a Pseudo Random Number Generator (PRNG), Linear Congruential Generator (LCG), or Mersenne twister algorithm.

16. The method of claim 1, wherein the seeds are generated via a cryptographic protocol.

17. The method of claim 1, wherein the seeds are generated via a Diffie-Hellman one-way key exchange protocol.

18. A computer-implemented method for a multiplicity of game service providers to of different jurisdictions to conduct common real time drawings in a game of chance, comprising:
arranging for the multiplicity of game service providers to pool revenue wagered from each jurisdiction into a common pot such that the winnings from the common real time drawing and associated game are paid to at least one winner in at least one jurisdiction in the game of chance;
storing an algorithm known to all the game service providers in a computer system, the computer system using the algorithm to determine the outcome of the game of chance's real time drawing(s);
inputting one or more seeds into the computer system as a variable input for the algorithm, the algorithm using the seeds for determination of the outcome of the game of chance's real time drawing(s);
wherein each of the game service providers contribute data or information for generation of the seeds that is maintained secret from the other respective party;
at a time when none of the game service providers can change their respective seed data or information, providing the one or more seeds to the game providers for independent verification of the algorithm outcome by the game provider and insurer; and
conducting payout in the game of chance in accordance with the outcome of the algorithm.

19. The method as in claim 18, wherein the game of chance is a poker game and the output of the real time drawing is used to shuffle a virtual deck of cards.

20. The method as in claim 18, wherein the game of chance is a Keno game and the output of the real time drawing is used to select Keno numbers.

21. The method as in claim 18, wherein the game of chance is a Bingo game and the output of the real time drawing is used to select Bingo numbers.

22. The method as in claim 18, wherein the seeds are exchanged in encrypted form between the game service providers, and the exchanged encryption keys after the exchange of the encrypted seeds.

23. The method as in claim 18, wherein each of the game service providers can independently verify the outcome of the algorithm with the other party's decrypted seed.

24. The method as in claim 18, wherein each of the game service providers provide a seed component to a separate event for determining a single combined seed that is input into the computer system for use by the algorithm, wherein the seed components are maintained secret from the other respective party.

25. The method as in claim 18, wherein at least one of the seed components is determined by a public source outside the control of any of the game service providers.
